(19) United States
(12) Patent Application Publication
(10) Pub. No.: US 2017/0180325 A1
(43) Pub. Date: Jun. 22, 2017

(54) TECHNOLOGIES FOR ENFORCING NETWORK ACCESS CONTROL OF VIRTUAL MACHINES

(71) Applicant: Intel Corporation, Santa Clara, CA (US)

(72) Inventors: Stephen T. Palermo, Chandler, AZ (US); Hari K. Tadepalli, Gilbert, AZ (US); Rashmin N. Patel, Chandler, AZ (US); Andrew J. Herdrich, Hillsboro, OR (US); Edwin Verplanke, Chandler, AZ (US)

(21) Appl. No.: 14/979,134

(22) Filed: Dec. 22, 2015

(51) Int. Cl. H04L 29/06; H04L 12/24

(52) U.S. Cl. CPC H04L 63/04; H04L 41/0806; H04L 63/102

(57) ABSTRACT

Technologies for enforcing virtual machine network access control include a network computing device that includes a plurality of virtual machines. The network computing device is configured to receive an access request from a virtual function assigned to a requesting virtual machine of the network computing device. The network computing device is additionally configured to determine a first privilege level assigned to the requesting machine and a second privilege level assigned to the destination virtual machine, and determine whether the requesting virtual machine is authorized to access the destination virtual machine based on a comparison of the first and second privilege levels. Upon determining the requesting virtual machine is authorized to access the destination virtual machine, the network computing device is additionally configured to allow the requesting virtual machine access to the destination virtual machine. Other embodiments are described herein.

### BACKGROUND

Network operators and communication service providers typically rely on complex, large-scale data centers comprised of a multitude of network computing devices (e.g., servers, switches, routers, etc.) to process network traffic through the data center. In order to provide scalability to meet network traffic processing demands and reduce operational costs, certain data center operations are typically run inside containers or virtual machines (VMs) in a virtualized environment of the network computing devices. To coordinate the functionality enabling physical hardware of a network computing device on which a VM is running with the virtual environment of the VM, the VM typically requires exposing a virtualized instance of a virtual function. For example, a virtual function, such as a PCI Express (PCIe) virtual function, can provide a mechanism for the direct transfer of data between the VM and a network interface controller (NIC) of the network computing device. To do so, the network computing device generally relies on a virtual function driver to manage the virtual function (e.g., read/write to the virtual function's configuration space).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for enforcing network access control of virtual machines by a network computing device;

FIG. 2 is a simplified block diagram of at least one embodiment of the network computing device of the system of FIG. 1;

FIG. 3 is a simplified block diagram of at least one embodiment of an environment that may be established by the network computing device of FIG. 2;

FIG. 4 is a simplified block diagram of another embodiment of an environment that may be established by the network computing device of FIG. 2;

FIG. 5 is a simplified flow diagram of at least one embodiment of a method for assigning a privilege level to an initialized virtual machine that may be executed by the network computing device of FIG. 2; and

FIG. 6 is a simplified flow diagram of at least one embodiment of a method for enforcing network access control of an initialized virtual machine that may be executed by the network computing device of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C): (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media (e.g., memory, data storage, etc.), which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

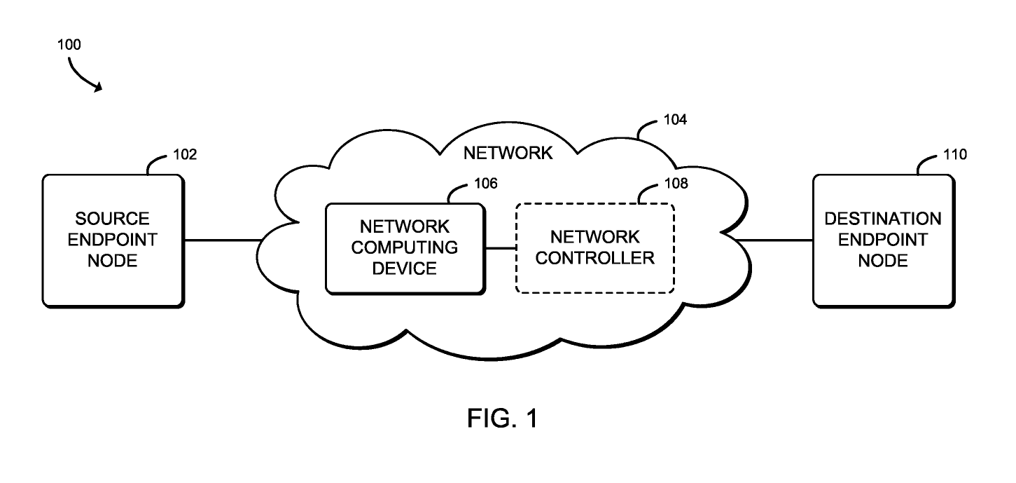

Referring now to FIG. 1, in an illustrative embodiment, a system 100 for enforcing network access control of virtual machines includes a source endpoint node 102 communicatively coupled to a destination endpoint node 110 via a network computing device 106 of a network 104. While only a single network computing device 106 is shown in the network 104 of the illustrative system 100, it should be appreciated that the network 104 may include a plurality of network computing devices 106 configured in various architectures.

In use, the network computing device 106 performs various operations (e.g., services) on network traffic (i.e., network packets, messages, etc.) received at the network computing device 106. It should be appreciated that the received network traffic may be dropped or forwarded, such as to additional other network computing devices communicatively coupled to the network computing device 106 or to the destination endpoint node 110. To process the network traffic, the network computing device 106 is configured to spin up multiple virtual machines (VMs) at the network computing device 106. Accordingly, the network computing device 106 is configured to map virtual representations of physical components of the network computing device 106 to virtualized components of the various VMs.

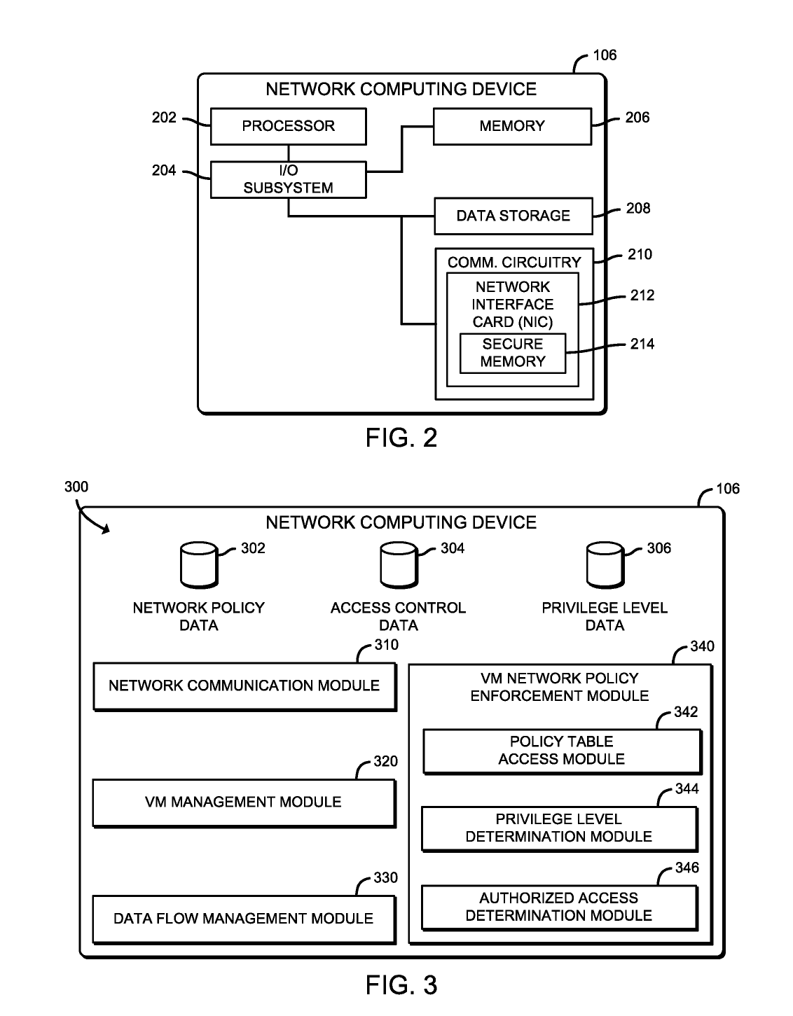

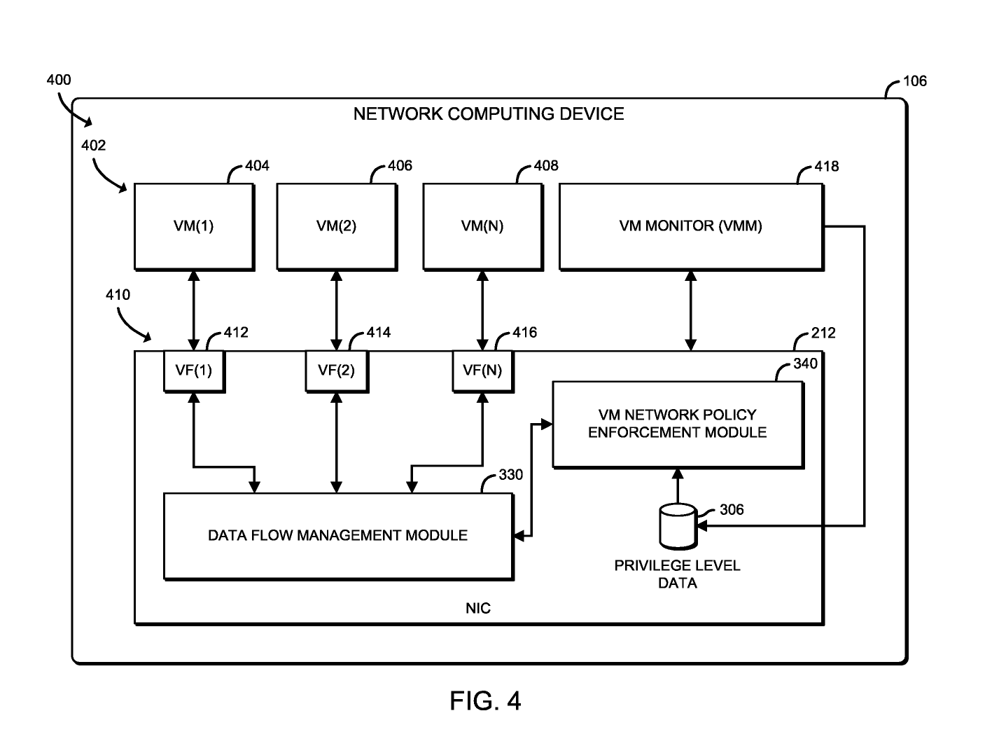

For example, a virtual network interface controller (NIC) may be initialized by the network computing device 106 to facilitate communications between a physical NIC (see, e.g., the NIC 212 of FIG. 2) and the virtual NIC. In such an embodiment, a virtual machine monitor (VMM) (see, e.g., the VMM 418 of FIG. 4) may be implemented to expose the virtual NICs to each of the instantiated VMs, such that all VM to VM communication passes through a single logical entity (i.e., the VMM). Similarly, the VMM may be configured to create virtual functions and virtual function drivers for assignment to the VMs to manage communications between the physical NIC and the virtual NIC. It should be appreciated that, in some embodiments, one or more of the VMs may be spawned on one or more other network computing devices communicatively coupled to the network computing device 106.

Flow director capabilities of the NIC 212 are configured to direct network traffic to the proper virtual functions (e.g., using an access control list (ACL) established by the VMM) of the VMs; however, during processing of the network traffic, the virtual function drivers are susceptible to manipulation by disruptive network packets, such as from malformed network packets, invalid memory access requests, restricted memory region access requests, restricted hardware access requests, etc., which typically result in a reset of the virtual device to clear a state of the virtual device upon detection of a disruptive network packet.

Accordingly, to pre-emptively determine whether the network traffic is allowable (e.g., within another VM of the network computing device 106, through another VM to a host external to the network computing device 106, etc.), the network computing device 106 (i.e., the NIC 212) is configured to implement hardware-based VM privilege levels. To do so, as described in further detail below, upon initialization of the VM, the VMM determines whether the VM is privileged or non-privileged and stores the privilege level (i.e., a privileged level or a non-privileged level) in a secure location, such as within a VM network privilege-level table at a secure memory of the NIC (see, e.g., the secure memory 214 of the NIC 212 of FIG. 2). In other words, the network computing device 106 is configured to control the network privileges rather than the execution privileges of the VM.

The source endpoint node 102 and/or the destination endpoint node 110 may be embodied as any type of computation or computer device capable of performing the functions described herein, including, without limitation, a portable computing device (e.g., smartphone, tablet, laptop, notebook, wearable, etc.) that includes mobile hardware (e.g., processor, memory, storage, wireless communication circuitry, etc.) and software (e.g., an operating system) to support a mobile architecture and portability, a computer, a server (e.g., stand-alone, rack-mounted, blade, etc.), a network appliance (e.g., physical or virtual), a web appliance, a distributed computing system, a processor-based system, and/or a multiprocessor system.

The network 104 may be embodied as any type of wired or wireless communication network, including a wireless local area network (WLAN), a wireless personal area network (WPAN), a cellular network (e.g., Global System for Mobile Communications (GSM), Long-Term Evolution (LTE), etc.), a telephony network, a digital subscriber line (DSL) network, a cable network, a local area network (LAN), a wide area network (WAN), a global network (e.g., the Internet), or any combination thereof. It should be appreciated that, in such embodiments, the network 104 may serve as a centralized network and, in some embodiments, may be communicatively coupled to another network (e.g., the Internet). Accordingly, the network 104 may include a variety of other network computing devices (e.g., virtual and physical routers, switches, network hubs, servers, storage devices, compute devices, etc.), as needed to facilitate communication between the source endpoint node 102 and the destination endpoint node 110, which are not shown to preserve clarity of the description.

The network computing device 106 may be embodied as any type of network traffic processing device that is capable of performing the functions described herein, such as, without limitation, a server (e.g., stand-alone, rack-mounted, blade, etc.), a network appliance (e.g., physical or virtual), a switch (e.g., rack-mounted, standalone, fully managed, partially managed, full-duplex, and/or half-duplex communication mode enabled, etc.), a router, a web appliance, a distributed computing system, a processor-based system, and/or a multiprocessor system.

As shown in FIG. 2, the illustrative network computing device 106 includes a processor 202, an input/output (I/O) subsystem 204, a memory 206, a data storage device 208, and communication circuitry 210. Of course, the network computing device 106 may include other or additional components, such as those commonly found in a computing device, in other embodiments. Additionally, in some embodiments, one or more of the illustrative components may be incorporated in, or otherwise form a portion of, another component. For example, the memory 206, or portions thereof, may be incorporated in the processor 202 in some embodiments. Further, in some embodiments, one or more of the illustrative components may be omitted from the network computing device 106.

The processor 202 may be embodied as any type of processor capable of performing the functions described herein. For example, the processor 202 may be embodied as a single or multi-core processor(s), digital signal processor, microcontroller, or other processor or processing/controlling circuit. Similarly, the memory 206 may be embodied as any type of volatile or non-volatile memory or data storage capable of performing the functions described herein. In operation, the memory 206 may store various data and software used during operation of the network computing device 106, such as operating systems, applications, programs, libraries, and drivers.

The memory 206 is communicatively coupled to the processor 202 via the I/O subsystem 204, which may be embodied as circuitry and/or components to facilitate input/output operations with the processor 202, the memory 206, and other components of the network computing device 106. For example, the I/O subsystem 204 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processor 202, the memory 206, and other components of the network computing device 106, on a single integrated circuit chip.

The data storage device 208 may be embodied as any type of device or devices configured for short-term or long-term storage of data such as, for example, memory devices and circuits, memory cards, hard disk drives, solid-state drives, or other data storage devices. It should be appreciated that the data storage device 208 and/or the memory 206 (e.g., the computer-readable storage media) may store various data as described herein, including operating systems, applications, programs, libraries, drivers, instructions, etc., capable of being executed by a processor (e.g., the processor 202) of the network computing device 106.

The communication circuitry 210 may be embodied as any communication circuit, device, or collection thereof, capable of enabling communications between the network computing device 106 and other computing devices (e.g., the source endpoint node 102, the destination endpoint node 110, another network computing device, etc.) over a network (e.g., the network 104). The communication circuitry 210 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

The illustrative communication circuitry 210 includes a NIC 212. The NIC 212 may be embodied as one or more add-in-boards, daughtercards, network interface cards, controller chips, chipsets, or other devices that may be used by the network computing device 106. For example, in some embodiments, the NIC 212 may be integrated with the processor 202, embodied as an expansion card coupled to the I/O subsystem 204 over an expansion bus (e.g., PCI Express), part of an SoC that includes one or more processors, or included on a multichip package that also contains one or more processors. Additionally or alternatively, in some embodiments, functionality of the NIC 212 may be integrated into one or more components of the network computing device 106 at the board level, socket level, chip level, and/or other levels.

The illustrative NIC 212 includes a secure memory 214. The secure memory 214 of the NIC 212 may be embodied as any type of memory that is configured to securely store data local to the NIC 212. It should be appreciated that, in some embodiments, the NIC 212 may further include a local processor (not shown) local to the NIC 212. In such embodiments, the local processor of the NIC 212 may be capable of performing functions (e.g., replication, network packet processing, etc.) that may be offloaded to the NIC 212.

Referring again to FIG. 1, the illustrative network 104 may additionally include a network controller 108 communicatively coupled to the network computing device 106. The network controller 108 may be embodied as any type of device, hardware, software, and/or firmware capable of directing the flow of network packets and managing policies of the network computing device 106 and performing the functions described herein, such as, without limitation, a server (e.g., stand-alone, rack-mounted, blade, etc.), a network appliance (e.g., physical or virtual), a switch (e.g., rack-mounted, standalone, fully managed, partially managed, full-duplex, and/or half-duplex communication mode enabled, etc.), a router, a web appliance, a distributed computing system, a processor-based system, and/or a multiprocessor system.

The network controller 108 may be configured to provide one or more policies (e.g., network policies) or instructions to the network computing device 106. It should be appreciated that, in some embodiments, the network controller 108 may be configured to operate in a software-defined networking (SDN) environment (i.e., an SDN controller) and/or a network functions virtualization (NFV) environment (i.e., an NFV manager and network orchestrator (MANO)). As such, the network controller 108 may include devices and components commonly found in a network control device or similar computing devices such as processors, memory, communication circuitry, and data storage devices, similar to those described for the network computing device 106 of FIG. 2, which are not shown in FIG. 1 for clarity of the description.

Referring now to FIG. 3, in an illustrative embodiment, the network computing device 106 establishes an environment 300 during operation. The illustrative environment 300 includes a network communication module 310, a virtual machine management module 320, a data flow management module 330, and a virtual network policy enforcement module 340. Each of the modules, logic, and other components of the environment 300 may be embodied as hardware, software, firmware, or a combination thereof. For example, each of the modules, logic, and other components of the environment 300 may form a portion of, or otherwise be established by, the processor 202, the communication circuitry 210 (e.g., the NIC 212), and/or other hardware components of the network computing device 106. As such, in some embodiments, one or more of the modules of the environment 300 may be embodied as circuitry or a collection of electrical devices (e.g., network communication circuitry 310, virtual machine management circuitry 320, data flow management circuitry 330, virtual network policy enforcement circuitry 340, etc.).

The illustrative environment 300 of the network computing device 106 additionally includes network policy data 302, access control data 304, and privilege level data 306, each of which may be accessed by the various modules and/or sub-modules of the network computing device 106. It should be appreciated that the network computing device 106 may include other components, sub-components, modules, sub-modules, and/or devices commonly found in a computing device, which are not illustrated in FIG. 3 for clarity of the description.

The network communication module 310 is configured to facilitate inbound and outbound network communications (e.g., network traffic, network packets, network flows, etc.) to and from the network computing device 106. To do so, the network communication module 310 is configured to receive and process network packets from other computing devices (e.g., the source endpoint node 102, the destination endpoint node 110, another network computing device communicatively coupled to the network computing device 106 via the network 104, etc.). Additionally, the network communication module 310 is configured to prepare and transmit network packets to another computing device (e.g., the source endpoint node 102, the destination endpoint node 110, another network computing device communicatively coupled to the network computing device 106 via the network 104, etc.). Accordingly, in some embodiments, at least a portion of the functionality of the network communication module 310 may be performed by the communication circuitry 210, and more specifically by the NIC 212.

The virtual machine management module 320 is configured to manage the VMs of the network computing device 106, as well as each of the virtual functions associated therewith (see, e.g., the VMs 400 and virtual functions 410 of FIG. 4). To do so, the virtual machine management module 320 is configured to deploy (i.e., spin-up, perform instantiation, etc.) and close (i.e., wind-down, remove from the network, etc.) the VMs based on the various service functions (e.g., based on service functions of a service function chain corresponding to the network packet stream) to be performed on the network traffic. Accordingly, the virtual machine management module 320 is configured to manage each of the virtual function drivers associated with the respective VMs.

The data flow management module 330 is configured to direct the flow of incoming network traffic to the appropriate virtual functions. In other words, the data flow management module 330 is configured to determine an intended destination (e.g., a VM) for which incoming network traffic is to be directed (i.e., based on an access request) and direct the incoming network traffic to an interface of the intended destination (i.e., a virtual function of the VM). However, prior to directing the network traffic to the intended, the access request is checked against a virtual network policy, such as may be performed by the virtual network policy enforcement module 340. In some embodiments, the virtual network policy may be stored in the network policy data 302. It should be appreciated that the access request may be a VM to VM access request, a VM to network access request (i.e., external network traffic targeted to go into or out of another VM), etc. It should be further appreciated that at least a portion of the flow director capabilities of the NIC 212, described above, may be performed by the data flow management module 330.

The virtual network policy enforcement module 340 is configured to enforce the virtual network policies of the network computing device 106 (e.g., VM to VM traffic policies, external traffic policies, etc.). Accordingly, the virtual network policy enforcement module 340 is configured to make packet processing decisions (e.g., whether to allow an access request) based on the policy information (e.g., a privilege level associated with the request originating VM and/or the request destination VM). To do so, the illustrative virtual network policy enforcement module 340 includes a policy table access module 342, a privilege level determination module 344, and an authorized access determination module 346.

The policy table access module 342 is configured to access an access control list (ACL) established by the VMM, which controls what network traffic is allowed between VMs. For example, upon initialization of a VM, the VMM determines whether that VM is privileged or non-privileged, and stores such information in the ACL. In some embodiments, such information may be stored in the access control data 304. The virtual network policy information may be based on an identifier of the network packet that may be contained in a header of the network packet, such as, for example, a media access control (MAC) address of the VM from which the network access control request was made, the MAC address of the destination VM. It should be appreciated that the virtual network policies may be received from a network controller or orchestrator (e.g., the network controller 108).

The privilege level determination module 344 is configured to determine a privilege level of an access requesting VM and a privilege level of a destination VM. It should be appreciated that the requesting VM and the destination VM may be the same VM or different VMs, depending on the type of request. To determine the privilege levels, the privilege level determination module 344 is configured to access a VM network privilege level table that includes privilege levels of each of the VMs, as well as a corresponding identifier (e.g., a domain identifier) of each of the VMs. In some embodiments, the VM network privilege level table (i.e., the privilege levels and corresponding identifiers) may be stored in the privilege level data 306. It should be appreciated that, in some embodiments, the privilege level data 306 may be stored in a secure portion (e.g., the secure memory 214) of the NIC 212, which may be secured using a trusted platform module technology, for example.

The authorized access determination module 346 is configured to determine whether to allow the access request to be transmitted to the destination VM, such as may be performed by the data flow management module 330. To do so, the authorized access determination module 346 is configured to compare the privilege level of the access requesting VM and the privilege level of the destination VM, such as may be determined by the privilege level determination module 344.

Referring now to FIG. 4, in another illustrative embodiment, the network computing device 106 establishes an environment 400 during operation. The illustrative environment 400 includes a plurality of VMs 402 executed on the network computing device 106, each of which is communicatively coupled to one of a plurality of virtual functions 410 of the NIC 212. The illustrative VMs 402 include a first VM, which is designated as VM (1) 404, a second VM, which is designated as VM (2) 406, and a third VM, which is designated as VM (N) 408 (i.e., the “Nth” computing node of the VMs 402, wherein “N” is a positive integer and designates one or more additional VMs 402). The illustrative virtual functions 410 include a first virtual function, which is designated as VF (1) 412, a second virtual function, which is designated as VF (2) 414, and a third virtual function, which is designated as VF (N) 416 (i.e., the “Nth” computing node of the virtual functions 410, wherein “N” is a positive integer and designates one or more additional virtual functions 410). Each of the virtual functions 408 are managed by the NIC 212 and traffic therebetween is managed by the data flow management module 330 of FIG. 3, described in detail above. The data flow management module 330 is further coupled to the virtual network policy enforcement module 340 of FIG. 3, which is also described in detail above. As shown, the NIC 212 of the illustrative embodiment 400 includes the privilege level data 306 of FIG. 3.

As also described previously, the contents of the privilege level data 306 (i.e., privilege levels and corresponding VM identifiers) are managed by the VMM 418, which is communicatively coupled to the NIC 212. The VMM 418 is responsible for controlling and handling of privileged instruction execution. Unlike traditional technologies that are configured to prevent applications from running or accessing platform shared resources, the network computing device 106 is configured to, as described previously, block undesirable network traffic prior to the undesirable network traffic being directed toward a particular VM via its corresponding virtual function. Accordingly, the network computing device 106 is configured to control network privileges rather than VM execution privileges. To do so, the network computing device 106 is configured to receive network privilege level information, such as from the network controller 108, during deployment of the VM hosting network related services. Upon the network controller 108 having selected a suitable node, the network controller 108 instructs the VMM 418 to apply the required privilege level, such as may be stored in the VM network privilege level table described previously.

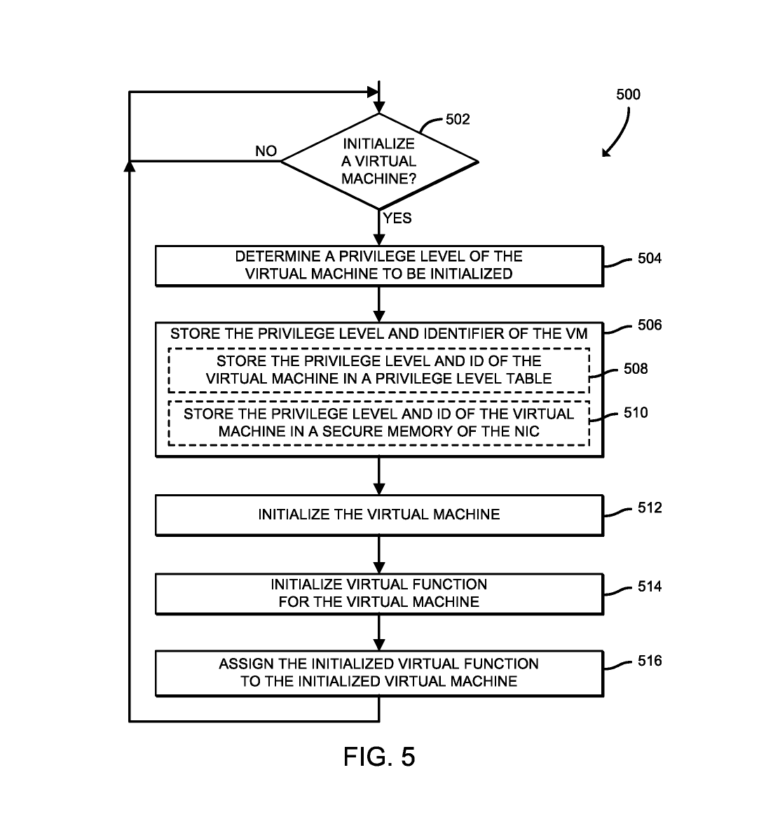

Referring now to FIG. 5, in use, the network computing device 106 may execute a method 500 for assigning a privilege level to an initialized VM. It should be appreciated that the method 500 may be executed for initial or unregistered access requests. The method 500 begins with block 502, in which the network computing device 106 determines whether a VM (e.g., one of the VMs 402 of FIG. 4) was requested for initialization (i.e., already instantiated) by the network computing device 106. If so, the method 500 advances to block 504, in which the network computing device 106 determines a privilege level (e.g., a privileged level or a non-privileged level) of the VM to be initialized. As described previously, the privilege level may be determined by a network controller 108 and received with or subsequent to having received a request for initialization of the VM.

In block 506, the network computing device 106 stores the privilege level of the VM to be initialized with an identifier of the VM to be initialized. In some embodiments, in block 508, the network computing device 106 stores the privilege level in an entry of the VM network privilege level table. Additionally or alternatively, in some embodiments, in block 510, the network computing device 106 stores the privilege level and identifier of the VM in a secure memory of the NIC (e.g., the secure memory 214 of the NIC 212 of FIG. 2). In block 512, the network computing device 106 initializes the VM. In block 514, the network computing device 106 initializes the virtual function and virtual function drivers for the VM initialized in block 512. In block 516, the network computing device 106 assigns the initialized virtual function to the VM initialized in block 512.

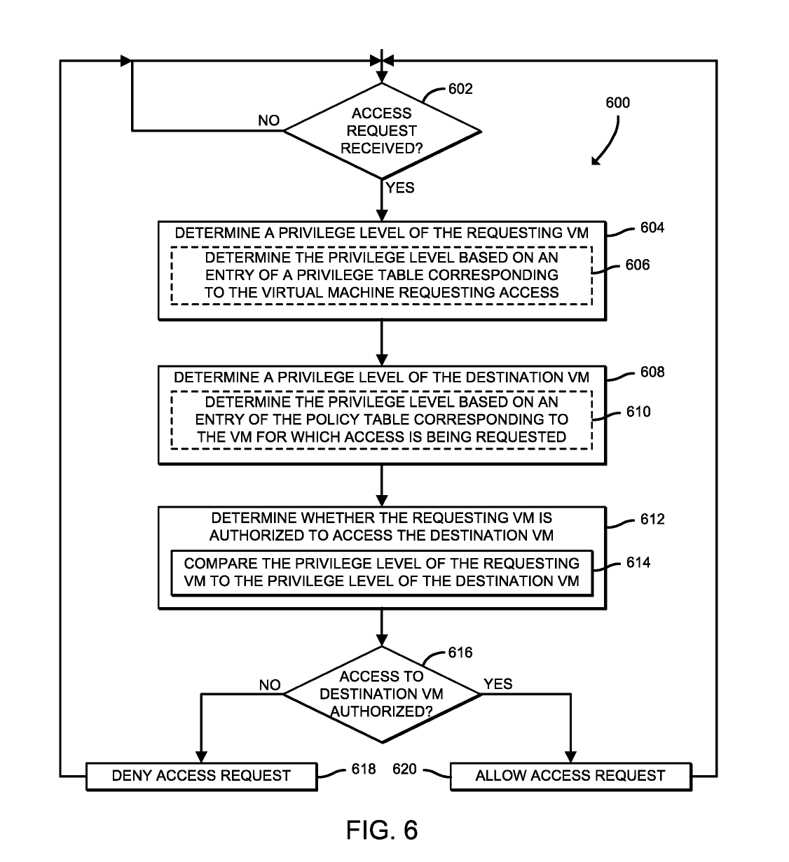

Referring now to FIG. 6, in use, the network computing device 106 may execute a method 600 for enforcing network access control of an initialized virtual machine. It should be appreciated that the method 600 may be executed subsequent to initial or unregistered access requests having been setup, as described in the method 500 FIG. 5. The method 600 begins with block 602, in which the network computing device 106 determines whether an access request was received from a VM (e.g., by the data flow management module 330 of FIGS. 3 and 4). As described previously, the access request may be a VM to VM access request, a VM to network access request (i.e., external network traffic targeted to go into or out of another VM), etc. If the network computing device 106 determines an access request was received from the VM, the network computing device 106 determines a privilege level of the requesting VM from which the access request was received. To do so, in some embodiments, in block 606, the network computing device 106 determines the privilege level of the requesting VM based on an entry of the VM network privilege level table that corresponds to the requesting VM.

In block 608, the network computing device 106 determines a privilege level of the destination VM for which access has been requested. To do so, in some embodiments, in block 610, the network computing device 106 determines the privilege level of the destination VM based on an entry of the VM network privilege level table that corresponds to the destination VM. In block 612, the network computing device 106 determines whether the VM requesting network access (i.e., the requesting VM) is authorized to access the destination VM. To do so, in block 614, the network computing device 106 compares the privilege level of the requesting VM determined in block 604 to the privilege level of the destination VM determined in block 608.

In block 616, the network computing device 106 determines whether the network access from the requesting VM to the destination VM is authorized based on the network policy. If not, the method 600 branches to block 618, in which the access request is denied; otherwise, if the access requested is authorized, the method 600 instead branches to block 620, in which the access request is allowed. For example, if the network computing device 106 determines the privilege level assigned to the requesting VM to be a privileged level and the privilege level assigned to the destination VM to be a privileged level, the network computing device 106 may allow the access request to be directed to the destination VM via the corresponding virtual function.

In another example, if the network computing device 106 determines the privilege level assigned to the requesting VM to be a privileged level and the privilege level assigned to the destination VM to be a non-privileged level, the network computing device 106 may allow the access request to be directed to the destination VM via the corresponding virtual function. In still another example, if the network computing device 106 determines the privilege level assigned to the requesting VM to be a non-privileged level and the privilege level assigned to the destination VM to be a privileged level, the network computing device 106 may deny the access request to be directed to the destination VM via the corresponding virtual function.

It should be appreciated that at least a portion of one or both of the methods 500 and 600 may be executed by the NIC 212 of the network computing device 106. It should be further appreciated that, in some embodiments, one or both of the methods 500 and 600 may be embodied as various instructions stored on a computer-readable media, which may be executed by the processor 202, the NIC 212, and/or other components of the network computing device 106 to cause the network computing device 106 to perform the methods 500 and 600. The computer-readable media may be embodied as any type of media capable of being read by the network computing device 106 including, but not limited to, the memory 206, the data storage device 208, a secure memory 214 of the NIC 212, other memory or data storage devices of the network computing device 106, portable media readable by a peripheral device of the network computing device 106, and/or other media.

### Examples

Illustrative examples of the technologies disclosed herein are provided below. An embodiment of the technologies may include any one or more, and any combination of, the examples described below.

Example 1 includes a network computing device for enforcing virtual machine network access control, the network computing device comprising one or more processors; and one or more data storage devices having stored therein a plurality of instructions that, when executed by the one or more processors, cause the network computing device to receive an access request from a virtual function assigned to a requesting virtual machine, wherein the requesting virtual machine is one of a plurality of virtual machines initialized on the network computing device, wherein the access request includes a request to access at least a portion of a destination virtual machine, wherein the destination virtual machine is one of the plurality of virtual machines initialized on the network computing device; determine a first privilege level assigned to the requesting machine and a second privilege level assigned to the destination virtual machine; determine whether the requesting virtual machine is authorized to access the destination virtual machine based on a comparison of the first and second privilege levels; and allow, in response to a determination the requesting virtual machine is authorized to access the destination virtual machine, the requesting virtual machine access to the destination virtual machine.

Example 2 includes the subject matter of Example 1, and wherein the plurality of instructions further cause the network computing device to initialize each of the plurality of virtual machines; and assign a privilege level to each of the plurality of virtual machines, wherein the privilege level comprises one of a privileged level or a non-privileged level.

Example 3 includes the subject matter of any of Examples 1 and 2, and wherein the plurality of instructions further cause the network computing device to initialize one or more virtual functions for each of the plurality of virtual machines; and assign each of the one or more virtual functions to a corresponding one of the plurality of virtual machines.

Example 4 includes the subject matter of any of Examples 1-3, and wherein to assign the privilege level to each of the plurality of virtual machines comprises to assign the first privilege level to the requesting virtual machine and the second privilege level to the destination virtual machine.

Example 5 includes the subject matter of any of Examples 1-4, and wherein to allow the requesting virtual machine access to the destination virtual machine comprises to allow access subsequent to a determination that the first privilege level corresponds to the privileged level and the second privilege level corresponds to the privileged level.

Example 6 includes the subject matter of any of Examples 1-5, and wherein to allow the requesting virtual machine access to the destination virtual machine comprises to allow access subsequent to a determination that the first privilege level corresponds to the privileged level and the second privilege level corresponds to the non-privileged level.

Example 7 includes the subject matter of any of Examples 1-6, and wherein the plurality of instructions further cause the network computing device to deny, in response to a determination the requesting virtual machine is not authorized to access the destination virtual machine, the requesting virtual machine access to the destination virtual machine.

Example 8 includes the subject matter of any of Examples 1-7, and wherein to assign the privilege level to each of the plurality of virtual machines comprises to assign the first privilege level to the requesting virtual machine and the second privilege level to the destination virtual machine, and wherein to deny the requesting virtual machine access to the destination virtual machine comprises to deny access subsequent to a determination that the first privilege level corresponds to the non-privileged level and the second privilege level corresponds to the privileged level.

Example 9 includes the subject matter of any of Examples 1-8, and wherein to allow the requesting virtual machine access to the destination virtual machine comprises to allow access limited to at least the portion of the destination virtual machine corresponding to the access request.

Example 10 includes the subject matter of any of Examples 1-9, and wherein the first and destination virtual machines are the same virtual machine.

Example 11 includes the subject matter of any of Examples 1-10, and wherein the first and destination virtual machines are different virtual machines.

Example 12 includes the subject matter of any of Examples 1-11, and wherein the access request comprises one of a VM to VM access request or a VM to network access request.

Example 13 includes a method for enforcing virtual machine network access control, the method comprising receiving, by a network computing device, an access request from a virtual function assigned to a requesting virtual machine, wherein the requesting virtual machine is one of a plurality of virtual machines initialized on the network computing device, wherein the access request includes a request to access at least a portion of a destination virtual machine, wherein the destination virtual machine is one of the plurality of virtual machines initialized on the network computing device; determining, by the network computing device, a first privilege level assigned to the requesting machine and a second privilege level assigned to the destination virtual machine; determining, by the network computing device, whether the requesting virtual machine is authorized to access the destination virtual machine based on a comparison of the first and second privilege levels; and allowing, by the network computing device and in response to a determination the requesting virtual machine is authorized to access the destination virtual machine, the requesting virtual machine access to the destination virtual machine.

Example 14 includes the subject matter of Example 13, and further including initializing, by the network computing device, each of the plurality of virtual machines; and assigning, by the network computing device, a privilege level to each of the plurality of virtual machines, wherein the privilege level comprises one of a privileged level or a non-privileged level.

Example 15 includes the subject matter of any of Examples 13 and 14, and further including initializing, by the network computing device, one or more virtual functions for each of the plurality of virtual machines; and assigning, by the network computing device, each of the one or more virtual functions to a corresponding one of the plurality of virtual machines.

Example 16 includes the subject matter of any of Examples 13-15, and wherein assigning the privilege level to each of the plurality of virtual machines comprises assigning the first privilege level to the requesting virtual machine and the second privilege level to the destination virtual machine.

Example 17 includes the subject matter of any of Examples 13-16, and wherein allowing the requesting virtual machine access to the destination virtual machine comprises allowing access subsequent to a determination that the first privilege level corresponds to the privileged level and the second privilege level corresponds to the privileged level.

Example 18 includes the subject matter of any of Examples 13-17, and wherein allowing the requesting, by the network computing device, virtual machine access to the destination virtual machine comprises allowing access subsequent to a determination that the first privilege level corresponds to the privileged level and the second privilege level corresponds to the non-privileged level.

Example 19 includes the subject matter of any of Examples 13-18, and further including denying, by the network computing device and in response to a determination the requesting virtual machine is not authorized to access the destination virtual machine, the requesting virtual machine access to the destination virtual machine.

Example 20 includes the subject matter of any of Examples 13-19, and wherein assigning the privilege level to each of the plurality of virtual machines comprises assigning the first privilege level to the requesting virtual machine and the second privilege level to the destination virtual machine, and wherein denying the requesting virtual machine access to the destination virtual machine comprises denying access subsequent to a determination that the first privilege level corresponds to the non-privileged level and the second privilege level corresponds to the privileged level.

Example 21 includes the subject matter of any of Examples 13-20, and wherein allowing the requesting virtual machine access to the destination virtual machine comprises allowing access limited to at least the portion of the destination virtual machine corresponding to the access request.

Example 22 includes the subject matter of any of Examples 13-21, and wherein the first and destination virtual machines are the same virtual machine.

Example 23 includes the subject matter of any of Examples 13-22, and wherein the first and destination virtual machines are different virtual machines.

Example 24 includes the subject matter of any of Examples 13-23, and wherein receiving the access request comprises receiving one of a VM to VM access request or a VM to network access request.

Example 25 includes a network computing device comprising a processor; and a memory having stored therein a plurality of instructions that when executed by the processor cause the network computing device to perform the method of any of Examples 13-24.

Example 26 includes one or more machine readable storage media comprising a plurality of instructions stored thereon that in response to being executed result in a network computing device performing the method of any of Examples 13-24.

Example 27 includes a network computing device for enforcing virtual machine network access control, the network computing device comprising network communication circuitry to receive an access request from a virtual function assigned to a requesting virtual machine, wherein the requesting virtual machine is one of a plurality of virtual machines initialized on the network computing device, wherein the access request includes a request to access at least a portion of a destination virtual machine, wherein the destination virtual machine is one of the plurality of virtual machines initialized on the network computing device; virtual machine network policy enforcement circuitry to (i) determine a first privilege level assigned to the requesting machine and a second privilege level assigned to the destination virtual machine and (ii) determine whether the requesting virtual machine is authorized to access the destination virtual machine based on a comparison of the first and second privilege levels; data flow management circuitry to allow, in response to a determination the requesting virtual machine is authorized to access the destination virtual machine, the requesting virtual machine access to the destination virtual machine.

Example 28 includes the subject matter of Example 27, and further including virtual machine management circuitry to initialize each of the plurality of virtual machines, wherein the virtual machine network policy enforcement circuitry is further to assign a privilege level to each of the plurality of virtual machines, wherein the privilege level comprises one of a privileged level or a non-privileged level.

Example 29 includes the subject matter of any of Examples 27 and 28, and wherein the virtual machine management circuitry is further to (i) initialize one or more virtual functions for each of the plurality of virtual machines and (ii) assign each of the one or more virtual functions to a corresponding one of the plurality of virtual machines.

Example 30 includes the subject matter of any of Examples 27-29, and wherein to assign the privilege level to each of the plurality of virtual machines comprises to assign the first privilege level to the requesting virtual machine and the second privilege level to the destination virtual machine.

Example 31 includes the subject matter of any of Examples 27-30, and wherein to allow the requesting virtual machine access to the destination virtual machine comprises to allow access subsequent to a determination that the first privilege level corresponds to the privileged level and the second privilege level corresponds to the privileged level.

Example 32 includes the subject matter of any of Examples 27-31, and wherein to allow the requesting virtual machine access to the destination virtual machine comprises to allow access subsequent to a determination that the first privilege level corresponds to the privileged level and the second privilege level corresponds to the non-privileged level.

Example 33 includes the subject matter of any of Examples 27-32, and wherein the data flow management circuitry is further to deny, in response to a determination the requesting virtual machine is not authorized to access the destination virtual machine, the requesting virtual machine access to the destination virtual machine.

Example 34 includes the subject matter of any of Examples 27-33, and wherein to assign the privilege level to each of the plurality of virtual machines comprises to assign the first privilege level to the requesting virtual machine and the second privilege level to the destination virtual machine, and wherein to deny the requesting virtual machine access to the destination virtual machine comprises to deny access subsequent to a determination that the first privilege level corresponds to the non-privileged level and the second privilege level corresponds to the privileged level.

Example 35 includes the subject matter of any of Examples 27-34, and wherein to allow the requesting virtual machine access to the destination virtual machine comprises to allow access limited to at least the portion of the destination virtual machine corresponding to the access request.

Example 36 includes the subject matter of any of Examples 27-35, and wherein the first and destination virtual machines are the same virtual machine.

Example 37 includes the subject matter of any of Examples 27-36, and the first and destination virtual machines are different virtual machines.

Example 38 includes the subject matter of any of Examples 27-37, and wherein the access request comprises one of a VM to VM access request or a VM to network access request.

Example 39 includes a network computing device for enforcing virtual machine network access control, the network computing device comprising network communication circuitry to receive an access request from a virtual function assigned to a requesting virtual machine, wherein the requesting virtual machine is one of a plurality of virtual machines initialized on the network computing device, wherein the access request includes a request to access at least a portion of a destination virtual machine, wherein the destination virtual machine is one of the plurality of virtual machines initialized on the network computing device; means for determining a first privilege level assigned to the requesting machine and a second privilege level assigned to the destination virtual machine; means for determining whether the requesting virtual machine is authorized to access the destination virtual machine based on a comparison of the first and second privilege levels; data flow management circuitry to allow, in response to a determination the requesting virtual machine is authorized to access the destination virtual machine, the requesting virtual machine access to the destination virtual machine.

Example 40 includes the subject matter of Example 39, and further including virtual machine management circuitry to initialize each of the plurality of virtual machines, wherein the virtual machine network policy enforcement circuitry is further to assign a privilege level to each of the plurality of virtual machines, wherein the privilege level comprises one of a privileged level or a non-privileged level.

Example 41 includes the subject matter of any of Examples 39 and 40, and wherein the virtual machine management circuitry is further to (i) initialize one or more virtual functions for each of the plurality of virtual machines and (ii) assign each of the one or more virtual functions to a corresponding one of the plurality of virtual machines.

Example 42 includes the subject matter of any of Examples 39-41, and wherein to assign the privilege level to each of the plurality of virtual machines comprises to assign the first privilege level to the requesting virtual machine and the second privilege level to the destination virtual machine.

Example 43 includes the subject matter of any of Examples 39-42, and wherein to allow the requesting virtual machine access to the destination virtual machine comprises to allow access subsequent to a determination that the first privilege level corresponds to the privileged level and the second privilege level corresponds to the privileged level.

Example 44 includes the subject matter of any of Examples 39-43, and wherein to allow the requesting virtual machine access to the destination virtual machine comprises to allow access subsequent to a determination that the first privilege level corresponds to the privileged level and the second privilege level corresponds to the non-privileged level.

Example 45 includes the subject matter of any of Examples 39-44, and wherein the data flow management circuitry is further to deny, in response to a determination the requesting virtual machine is not authorized to access the destination virtual machine, the requesting virtual machine access to the destination virtual machine.

Example 46 includes the subject matter of any of Examples 39-45, and wherein the means for assigning the privilege level to each of the plurality of virtual machines comprises means for assigning the first privilege level to the requesting virtual machine and the second privilege level to the destination virtual machine, and wherein to deny the requesting virtual machine access to the destination virtual machine comprises to deny access subsequent to a determination that the first privilege level corresponds to the non-privileged level and the second privilege level corresponds to the privileged level.

Example 47 includes the subject matter of any of Examples 39-46, and wherein to allow the requesting virtual machine access to the destination virtual machine comprises to allow access limited to at least the portion of the destination virtual machine corresponding to the access request.

Example 48 includes the subject matter of any of Examples 39-47, and wherein the first and destination virtual machines are the same virtual machine.

Example 49 includes the subject matter of any of Examples 39-48, and wherein the first and destination virtual machines are different virtual machines.

Example 50 includes the subject matter of any of Examples 39-49, and wherein the access request comprises one of a VM to VM access request or a VM to network access request.

1. A network computing device for enforcing virtual machine network access control, the network computing device comprising:
one or more processors; and
one or more data storage devices having stored therein a plurality of instructions that, when executed by the one or more processors, cause the network computing device to:
receive an access request from a virtual function assigned to a requesting virtual machine, wherein the requesting virtual machine is one of a plurality of virtual machines initialized on the network computing device, wherein the access request includes a request to access at least a portion of a destination virtual machine, wherein the destination virtual machine is one of the plurality of virtual machines initialized on the network computing device;
determine a first privilege level assigned to the requesting machine and a second privilege level assigned to the destination virtual machine;
determine whether the requesting virtual machine is authorized to access the destination virtual machine based on a comparison of the first and second privilege levels; and
allow, in response to a determination the requesting virtual machine is authorized to access the destination virtual machine, the requesting virtual machine access to the destination virtual machine.

2. The network computing device of claim 1, wherein the plurality of instructions further cause the network computing device to:
initialize each of the plurality of virtual machines; and
assign a privilege level to each of the plurality of virtual machines, wherein the privilege level comprises one of a privileged level or a non-privileged level.

3. The network computing device of claim 2, wherein the plurality of instructions further cause the network computing device to:
initialize one or more virtual functions for each of the plurality of virtual machines; and
assign each of the one or more virtual functions to a corresponding one of the plurality of virtual machines.

4. The network computing device of claim 2, wherein to assign the privilege level to each of the plurality of virtual machines comprises to assign the first privilege level to the requesting virtual machine and the second privilege level to the destination virtual machine.

5. The network computing device of claim 4, wherein to allow the requesting virtual machine access to the destination virtual machine comprises to allow access subsequent to a determination that the first privilege level corresponds to the privileged level and the second privilege level corresponds to the privileged level, or a determination that the first privilege level corresponds to the privileged level and the second privilege level corresponds to the non-privileged level.

6. The network computing device of claim 2, wherein the plurality of instructions further cause the network computing device to deny, in response to a determination the requesting virtual machine is not authorized to access the destination virtual machine, the requesting virtual machine access to the destination virtual machine.

7. The network computing device of claim 6, wherein to assign the privilege level to each of the plurality of virtual machines comprises to assign the first privilege level to the requesting virtual machine and the second privilege level to the destination virtual machine, and wherein to deny the requesting virtual machine access to the destination virtual machine comprises to deny access subsequent to a determination that the first privilege level corresponds to the non-privileged level and the second privilege level corresponds to the privileged level.

8. The network computing device of claim 1, wherein to allow the requesting virtual machine access to the destination virtual machine comprises to allow access limited to at least the portion of the destination virtual machine corresponding to the access request.

9. The network computing device of claim 1, wherein the first and destination virtual machines are the same virtual machine.

10. The network computing device of claim 1, wherein the first and destination virtual machines are different virtual machines.

11. The network computing device of claim 1, wherein the access request comprises one of a VM to VM access request or a VM to network access request.

12. One or more computer-readable storage media comprising a plurality of instructions stored thereon that in response to being executed cause a network computing device to:
receive an access request from a virtual function assigned to a requesting virtual machine, wherein the requesting virtual machine is one of a plurality of virtual machines initialized on the network computing device, wherein the access request includes a request to access at least a portion of a destination virtual machine, wherein the destination virtual machine is one of the plurality of virtual machines initialized on the network computing device;
determine a first privilege level assigned to the requesting machine and a second privilege level assigned to the destination virtual machine;
determine whether the requesting virtual machine is authorized to access the destination virtual machine based on a comparison of the first and second privilege levels; and
allow, in response to a determination the requesting virtual machine is authorized to access the destination virtual machine, the requesting virtual machine access to the destination virtual machine.

13. The one or more computer-readable storage media of claim 12, wherein the plurality of instructions further cause the network computing device to:
initialize each of the plurality of virtual machines; and
assign a privilege level to each of the plurality of virtual machines, wherein the privilege level comprises one of a privileged level or a non-privileged level.

14. The one or more computer-readable storage media of claim 13, wherein the plurality of instructions further cause the network computing device to:
initialize one or more virtual functions for each of the plurality of virtual machines; and
assign each of the one or more virtual functions to a corresponding one of the plurality of virtual machines.

15. The one or more computer-readable storage media of claim 13, wherein to assign the privilege level to each of the plurality of virtual machines comprises to assign the first privilege level to the requesting virtual machine and the second privilege level to the destination virtual machine.

16. The one or more computer-readable storage media of claim 15, wherein to allow the requesting virtual machine access to the destination virtual machine comprises to allow access subsequent to a determination that the first privilege level corresponds to the privileged level and the second privilege level corresponds to the privileged level, or a determination that the first privilege level corresponds to the privileged level and the second privilege level corresponds to the non-privileged level.

17. The one or more computer-readable storage media of claim 12, wherein the plurality of instructions further cause the network computing device to deny, in response to a determination the requesting virtual machine is not authorized to access the destination virtual machine, the requesting virtual machine access to the destination virtual machine.

18. The one or more computer-readable storage media of claim 17, wherein to assign the privilege level to each of the plurality of virtual machines comprises to assign the first privilege level to the requesting virtual machine and the second privilege level to the destination virtual machine, and wherein to deny the requesting virtual machine access to the destination virtual machine comprises to deny access subsequent to a determination that the first privilege level corresponds to the non-privileged level and the second privilege level corresponds to the privileged level.

19. The one or more computer-readable storage media of claim 21, wherein to allow the requesting virtual machine access to the destination virtual machine comprises to allow access limited to at least the portion of the destination virtual machine corresponding to the access request.

20. The one or more computer-readable storage media of claim 12, wherein the first and destination virtual machines are the same virtual machine.

21. The one or more computer-readable storage media of claim 12, wherein the first and destination virtual machines are different virtual machines.

22. The one or more computer-readable storage media of claim 12, wherein the access request comprises one of a VM to VM access request or a VM to network access request.

23. A target computing node for tracking out-of-order network packets, the target computing node comprising:
network communication management circuitry to establish a communication channel with a source computing node via a network; and
means for generating an entry of a packet sequence number table corresponding to the communication channel, wherein the entry includes a small window that defines a portion of memory of the target computing node allocated to store a bit mask corresponding to a number of out-of-order network packets received by the target computing node through the communication channel;
wherein the network communication management circuitry is further to receive a plurality of out-of-order network packets from the source computing node via the communication channel, and
further comprising means for updating the bit mask in the small window of the packet sequence number table corresponding to the communication channel as a function of a packet sequence number of each of the plurality of out-of-order network packets received from the source computing node.

24. The target computing node of claim 23, wherein the means for updating the bit mask in the packet sequence number table comprises means for (i) determining whether a size of the bit mask is larger than a size of the small window, (ii) allocating, in response to a determination the size of the bit mask is larger than the size of the small window, a large window that defines another portion of memory of the target computing node allocated to store the bit mask corresponding to a number of out-of-order network packets received by the target computing node through the communication channel, wherein a size of the large window exceeds the size of the bit mask, (iii) storing the bit mask in the large window, and (iv) storing a pointer to the large window in the small window.

25. The target computing node of claim 24, wherein the network communication management circuitry is further to receive an additional out-of-order network packet, and
further comprising means for (i) updating the bit mask in the large window as a function of the received additional out-of-order network packet, (ii) determining whether additional network packets are being tracked, and (iii) updating, in response to a determination that no additional network packets are being tracked, the small window to store the bit mask and not the pointer to the large window.
